(19) United States
(12) Patent Application Publication
(10) Pub. No.: US 2009/0056620 A1
(43) Pub. Date: Mar. 5, 2009

(54) Thermal spraying nozzle device and thermal spraying system using the same

(75) Inventors: Tsuyoshi Oda, Hyogo (JP); Hideo Hata, Hyogo (JP); Yasushi Maeda, Hyogo (JP); Kazuhisa Fukutani, Hyogo (JP)

Correspondence Address: REED SMITH LLP, 3110 FAIRVIEW PARK DRIVE, SUITE 1400, FALLS CHURCH, VA, 22042, US

(73) Assignee: KABUSHIKI KAISHA KOBE SEIKO SHO

(21) Appl. No.: 11/665,764

(22) PCT Filed: Nov. 24, 2005
(86) PCT No.: PCT/JP2005/021555

§ 371 Date: Apr. 19, 2007

(30) Foreign Application Priority Data
Nov. 24, 2004 (JP) 2004-339321

(51) Int. Cl. B05C 5/00

(52) U.S. Cl. 118/300

(57) ABSTRACT

[Subject]

A thermal spraying nozzle device capable of accurately forming a uniform and compact metal laminate, as well as a thermal spraying system using the thermal spraying nozzle device, are to be provided.

[Solution]

A thermal spraying nozzle device wherein carrier gas is introduced into an inlet side of a nozzle (1) to form a supersonic gas flow in the entire region inside the nozzle and a thermal spraying material is atomized and ejected by the gas flow, the thermal spraying nozzle device comprising a thermal spraying material inserting section (5) for insertion therethrough of the thermal spraying material (4) formed in a linear shape into the nozzle (1) from the inlet side substantially in parallel with the gas flow and a laser device for heating and melting the thermal spraying material projected from the thermal spraying material inserting section in the vicinity of a front end of the thermal spraying material inserting section, particles of the thermal spraying material melted and atomized by the laser device being cooled quickly by the supersonic gas flow in the nozzle (1) and ejected in a solidified or semi-solidified state.

### TECHNICAL FIELD

The present invention relates to a thermal spraying nozzle device capable of being used for various purposes as a thermal spraying nozzle to form a surface coating layer on a base material and as an injection nozzle to form a three-dimensional laminate, as well as a thermal spraying system using the thermal spraying nozzle device.

### BACKGROUND ART

Today, a cold spraying technique is becoming more and more popular in which a material is brought into collision with a base material while it is in a solid phase as a supersonic flow together with an inert gas without being melted or gasified, thereby forming a film (see, for example, Japanese Patent Laid-Open No. 2004-76157, Patent Literature 1).

The cold spraying technique, unlike other thermal spraying methods, is advantageous in that there occurs no change in characteristics of a material used under the application of heat and that it is possible to suppress oxidation in the film formed. Besides, the cold spraying technique is applicable not only to metal but also to resin. The cold spraying technique of this type mainly aims at forming a film, but it has also been proposed to apply the same technique to a thermal spraying method aiming at the production of a three-dimensional molding.

As a method which has made it possible to produce a three-dimensional molding there is a molding method utilizing a three-dimensional CAD which has recently spread in quick tempo.

A so-called three-dimensional laminate molding method for forming a three-dimensional structure by utilizing the three-dimensional CAD is called rapid prototyping, in which a solid model (a three-dimensional model) is formed directly (three-dimensional laminate molding) while laminating layer by layer without machining and with use of shape data inputted on the three-dimensional CAD. This method has initially been developed as a method for forming a trial product or the like in a short time.

Since it has recently become possible to form a mold by utilizing the rapid prototyping referred to above, the rapid prototyping is now spreading widely on the ground that the time required from product development until shipping can be shortened and hence the reduction of cost can be attained also in the manufacturing industry, including automobiles and consumer electronics, other than the trial product field.

As three-dimensional laminate molding methods there are known a) an optical molding method using a photo-setting resin, b) a powder lamination method using powder, c) an ink jet method, and d) a sheet lamination method involving laminating sheets such as paper, plastic or metal sheets.

In connection with the optical molding method a) there is known, for example, an SLA1 system manufactured and sold by 3D Systems Co., Valencia, Calif. According to this system, a laser beam is irradiated to a surface by utilizing UV laser, liquid polymer plastic material to polymerize the material and form a layer, then the layer is brought down, and the laser polymerization process is repeated until a desired layer thickness is obtained, to effect molding.

As the powder lamination method b) there is known a method called a selective laser sintering (SLS) method proposed by DTM Co., Austin, Tex. This method also utilizes a laser beam to sinter a plastic powder layer.

The ink jet method c) is broadly classified into two types of methods, one of which has been developed by Massachusetts Institute of Technology and in which a binder is injected by an ink jet method to a layer of starch or gypsum layer and is hardened to form a laminate. The other method is a laminate molding method involving direct injection of a molding material.

The ink jet method of injecting and hardening a binder involves the problem that the powder of an unnecessary portion must be removed after the end of the injection and that the powder scatters during the removal thereof. On the other hand, the ink jet method of directly injecting a molding material permits easy handling of the device concerned because there is no scattering of material particles.

According to the sheet lamination method d), a thin metal foil layer is cut into an appropriate shape to form a part and molded pieces for lamination are stacked and joined one on another to form the associated part.

Most of the rapid prototyping methods thus utilized over a wide range aim at molding with use of resin. It is only the foregoing powder lamination method b) utilizing selective laser sintering that permits metal molding. In the powder lamination method utilizing laser sintering, however, it is necessary that the surface of a metal powder as the material be coated with a binder, or a low melting metal powder be incorporated therein, thus resulting in increase of the material cost. Moreover, after the sintering, a binder-free portion remains in a porous state, thus giving rise to the problem that a sufficient strength is not obtained, which problem remains to be solved. A slow cooling process is also needed for the purpose of preventing a thermal strain after the sintering. Thus, for utilizing the powder lamination method based on laser sintering as a metal molding method, there still remains room for improvement and at present the method in question is still in a research phase.

Under the circumstances there have been proposed a technique (see, for example, Japanese Patent Laid-Open No. Hei 11(1999)-165061, Patent Literature 2) in which a material ejected from a nozzle is heat-melted with laser light and the material thus melted is discharged to a base material with the pressure of compressed gas and a technique (see, for example, Japanese Patent Laid-Open No. 2004-292940, Patent Literature 3) in which a wire rod of a metallic material fed in parallel with a gas flow is melted by electric discharge and is flied into air by the gas flow.

Patent Literature 1:

Japanese Patent Laid-Open No. 2004-76157

Patent Literature 2:

Japanese Patent Laid-Open No. Hei 11(1999)-165061

Patent Literature 3:

Japanese Patent Laid-Open No. 2004-292940

### DISCLOSURE OF THE INVENTION

However, according to the technique described in Patent Literature 2, there are provided a holding section for holding a thermal spraying material and an opposite section disposed in opposition to the holding section through a predetermined spacing from an end face of the holding section, and the thermal spraying material projected from the holding section is brought into abutment against a reference surface of the opposite section, then is heat-melted with a laser beam, further, the pressure of compressed gas is applied to the melted thermal spraying material in a direction orthogonal to the thermal spraying material. Consequently, a gas flow is disturbed by the thermal spraying material which projects so as to obstruct a flow path and it is difficult to control the state of lamination on the base material.

According to the technique described in Patent Literature 3, a fine hole for the feed of gas is formed in an injection device body formed with a nozzle, a guide pipe for passing therethrough of a wire rod is disposed within the fine hole, and a first electrode is disposed near a front end of the fine hole, while a second electrode is disposed on an extension line of the wire rod at a position away from the fine hole. Voltage is applied between the electrodes to melt the wire rod positioned between the electrodes, thereby forming a melted ball, and with a gas flow the melted ball is cut off from the wire rod and flied. According to this technique described in Patent Literature 3, the melted ball can be ejected in a uniform size, but the melted ball is flied with a gas flow after ejected radially from the nozzle, so also in this case it is difficult to control the state of lamination on a base material.

The present invention has been accomplished in view of the above-mentioned problems involved in the above conventional thermal spraying methods and provides a thermal spraying nozzle device capable of forming a uniform and compact metal laminate accurately, as well as a thermal spraying system using the thermal spraying nozzle device.

The thermal spraying nozzle device according to the present invention is, in the gist thereof, a thermal spraying nozzle device wherein carrier gas is introduced into an inlet side of a nozzle to form a supersonic gas flow in the entire region inside the nozzle and thermal spraying material is atomized and ejected by said gas flow, the thermal spraying nozzle device comprising, a thermal spraying material inserting section for inserting the thermal spraying material formed in a linear shape into the nozzle from the inlet side substantially in parallel with the gas flow, and, a thermal spraying material melting means for heating and melting the thermal spraying material projected from the thermal spraying material inserting section in the vicinity of a front end of the thermal spraying material inserting section, wherein the thermal spraying nozzle device is configured such that particles of the thermal material melted and atomized through the thermal spraying material melting means are quickly cooled by the supersonic gas flow in the nozzle and then ejected in a solidified or semi-solidified state.

As the thermal spraying material melting means in the above thermal spraying nozzle device there may be provided a laser device which focuses near the front end of the thermal spraying material inserting section. Moreover, a pair of discharging electrodes may be provided in a mutually opposed state on the inner wall of the nozzle so that an arc discharge passes near the front end of the thermal spraying material inserting section.

Further, the thermal spraying material inserting section is constructed so as to permit insertion of plural pieces of the thermal spraying material into the nozzle, and front end portions of the thermal spraying material pieces are formed as discharging electrodes for generating an arc discharge, thereby constituting the thermal spraying material melting means. In this case, if there are provided a hollow chamber on the nozzle inlet side and two carrier gas supply pipes communicating with the hollow chamber to introduce the carrier gas as counter flows and if cylindrical thermal spraying material inserting sections are disposed respectively at positions where they collide with the carrier gas discharged from the carrier gas supply pipes toward the hollow chamber, it is possible to diminish a rotating flow in a section perpendicular to the intra-nozzle flow direction. As a result, it is possible to diminish a flow component which blows a melted droplet at an arc melting point against the wall surface.

In the above thermal spraying nozzle device, if a hollow pipe of a circular section is disposed on the central axis of the nozzle as the thermal spraying material inserting section, then by forming thick a part of the outer wall of the hollow circular pipe, a throat portion for forming a supersonic gas flow can be formed between the hollow circular pipe and the inner wall of the nozzle.

In the above thermal spraying nozzle device, if there is provided heating means for heating solidified particles of the thermal spraying material adhered to the inner wall of the nozzle up to a temperature of not lower than the melting point of the particles, then by the supply of only the carrier gas simultaneously with the heating, it is possible to effect cleaning for removing the particles of the thermal spraying material adhered to the inner wall of the nozzle.

If the heating means is configured so as to heat the thermal spraying material in the nozzle during thermal spraying, it is possible to set the temperature of the particles of the thermal spraying material at a desired temperature when colliding with a base material, whereby an optimum adhesion is attained.

The above heating means may be constituted by winding a high frequency induction coil round the nozzle or by disposing a carbon heater around the nozzle. It is also possible to let the nozzle itself serve as the heating means by constituting it with use of carbon or carbon composite provided with an electrode portion.

If there is provided temperature adjusting means for adjusting the temperature of the particles of the thermal spraying material in the nozzle to a predetermined temperature, an optimum adhesion is attained because the temperature of the particles can be set to a desired temperature when colliding with a base material.

If a thermal spraying material formed of different materials is used as the above thermal spraying material, it becomes possible to select an alloy as the thermal spraying material.

The thermal spraying system according to the present invention, in the gist thereof, comprises the thermal spraying device of the construction described above, a carrier gas supply unit for the supply of carrier gas, the carrier gas supply unit being connected to the nozzle through a conduit, a thermal spraying material supply unit for feeding the thermal spraying material formed in a linear shape into the thermal spraying material inserting section, and a power supply unit for applying voltage to the discharging electrodes or the laser device serving as the thermal spraying material melting means.

If the above thermal spraying system further comprises a control valve disposed in the conduit to control the flow rate of the carrier gas supplied from the carrier gas supply unit, a reel serving as the thermal spraying material supply unit and with the linear thermal spraying material wound thereon, a driving roller for introducing the thermal spraying material into the thermal spraying material inserting section while unwinding the thermal spraying material, and a supply system control section for controlling opening/closing of the control valve and rotation/stop of the driving roller, it becomes possible to control the thermal spraying material to be laminated or deposited on the base material.

If the thermal spraying system further comprises a motor for rotating the driving roller and a position sensor for measuring the distance just before deposition from the nozzle up to an already deposited surface and if the supply system control section reads in three-dimensional CAD data and controls the rotation of the motor in accordance with a difference between a level detected by the position sensor and the level of a target deposition surface in the three-dimensional CAD data, it becomes possible to control more accurately the thermal spraying material to be laminated or deposited.

The above thermal spraying system may further comprise an output control section for controlling voltage to be applied to the discharging electrodes or output of the laser device.

In the case where the thermal spraying system is provided as the above thermal spraying material melting means with a laser device and a laser light transmitting optical fiber which provides a connection between the laser device and the nozzle, the output control section may be configured to control opening and closing of a shutter of the laser device and thereby control melting of the thermal spraying material.

If the thermal spraying system further comprises a temperature sensor for detecting the temperature of gas ejected from the nozzle, heating means disposed around the nozzle or serving as the nozzle, and temperature adjusting means for adjusting the temperature of the thermal spraying material particles in the nozzle to a predetermined temperature and if the temperature adjusting means controls voltage to be applied to the heating means on the basis of the temperature detected by the temperature sensor, it becomes possible to accurately control the temperature of the particles of the thermal spraying material in the nozzle.

If the thermal spraying system further comprises a drive mechanism for displacing the attitude of the nozzle and a drive system control section for controlling the drive mechanism and if the drive system control section reads in three-dimensional CAD data, prepares sectional data sliced to a laminate thickness on the basis of the three-dimensional CAD data thus read in and then, on the basis of the sectional data, controls the drive mechanism in such a manner that the thermal spraying material particles melted by the thermal spraying material melting means are deposited layer by layer on the base material, it becomes possible to form a three-dimensional solid model.

According to the thermal spraying nozzle device of the present invention it is possible to form a uniform and compact metal laminate accurately.

According to the thermal spraying nozzle device of the present invention, since the thermal spraying material inserting section is disposed in parallel with the gas flow, the gas flow is not disturbed. Further, according to the thermal spraying nozzle device provided with heating means, since the thermal spraying material particles adhered to the inner wall of the nozzle are melted and peeled off by the heating means, it is possible to attain a cleaning effect.

According to the thermal spraying system of the present invention, it is possible to accurately control the thermal spraying material to be laminated onto the base material. Further, according to the thermal spraying system which controls the attitude of the nozzle on the basis of three-dimensional CAD data, it is possible to form a three-dimensional solid model accurately.

### BRIEF DESCRIPTION OF THE DRAWINGS

FIG. 1 is a sectional view showing the construction of a thermal spraying nozzle device according to the present invention.

FIG. 2 is an explanatory diagram showing the construction of a heating device for a thermal spraying nozzle.

FIG. 3 is an explanatory diagram showing a relation between a sectional area of a throat portion and that of a heat-melting section in the nozzle.

FIG. 4(a) is a graph showing a relation between the temperature of intra-nozzle particles and the velocity of particles in the use of nitrogen gas, and FIG. 4(b) is an enlarged graph of a principal portion of FIG. 4(a).

FIG. 5(a) is a graph showing a relation between the temperature of intra-nozzle particles and the velocity of particles in the use of helium gas, and FIG. 5(b) is an enlarged graph of a principal portion of FIG. 5(a).

FIG. 6 is a construction diagram showing a construction in case of using a thermal spraying system according to the present invention as a film forming system.

FIG. 7 is a sectional view of a principal portion, showing another construction in case of using the thermal spraying system according to the present invention as a film forming system.

FIG. 8 is a perspective view showing a thermal spraying nozzle according to another embodiment of the present invention.

FIG. 9 is a sectional side view showing a trace of particles in the thermal spraying nozzle shown in FIG. 8.

FIG. 10 is a sectional plan view showing a trace of particles in the thermal spraying nozzle shown in FIG. 8.

FIG. 11 is a sectional side view showing a flow of carrier gas in the thermal spraying nozzle shown in FIG. 8.

FIG. 12(a) is an explanatory diagram showing a flow of carrier gas in E-E section of FIG. 11, and FIG. 12(b) is an explanatory diagram showing a flow of carrier gas and the state of particles in F-F section of FIG. 11.

FIG. 13 is an explanatory diagram showing a flow velocity distribution of carrier gas in the nozzle.

FIG. 14 is a block diagram showing a construction in case of using the thermal spraying system according to the present invention in three-dimensional deposition molding.

FIG. 15 is an explanatory diagram showing a method for controlling the amount of thermal spraying material particles to be deposited.

FIG. 16 is a vertical sectional view showing another embodiment of thermal spraying nozzle heating device according to the present invention.

FIG. 17 is a perspective view showing the construction of a carbon heater shown in FIG. 16.

FIG. 18 is a vertical sectional view showing a further embodiment of a thermal spraying nozzle heating device according to the present invention.

### BEST MODE FOR CARRYING OUT THE INVENTION

The present invention will be described in detail hereinunder on the basis of the embodiments illustrated in the drawings.

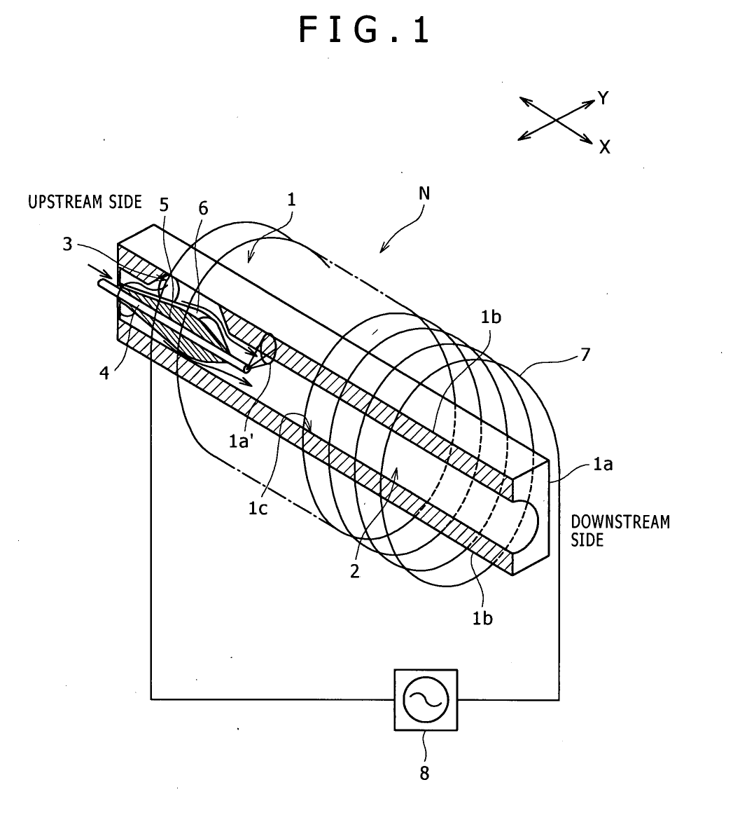

FIG. 1 illustrates the construction of a thermal spraying nozzle device N according to the present invention.

In the same-figure, a passage 2 having a constant inside diameter is formed in the interior of the nozzle 1 in the nozzle axis direction. On an upstream side (in a carrier gas flow direction) of the passage 2 is formed a carrier gas supply port 3. Further, on the upstream side and on the central axis of the passage 2 is disposed a guide (a thermal spraying material inserting section) 5 which is a hollow pipe of a circular section for feeding out wire 4 as a thermal spraying material toward a downstream side.

An outer surface of the guide 5 is expanded in diameter gradually toward the downstream side, whereby there is formed a throat portion 6 providing a narrowest annular gap between it and an inner surface of the passage 2. On the downstream side of the throat portion 6 the diameter of the outer surface of the guide 5 is again reduced.

The length of the nozzle 1 is set to 20 to 40 times as large as the inside diameter of the nozzle, thus affording a long rectilinear portion, whereby thermal spraying material particles (hereinafter referred to simply as “particles”) melted in the nozzle 1 fly in parallel with the nozzle. Consequently, the expanse of the particles is suppressed and it is thereby possible to enhance a hit accuracy against a base material.

At a position somewhat spaced away to the downstream side from a front end of the guide 5, i.e., on the downstream side relative to the throat portion 6, an optical axis of a Yb fiber laser (hereinafter referred to simply as the “laser device”) passes across the passage 2 in Y axis direction from one side face la of the nozzle 1 toward an opposite side face, and a laser beam is focused on a front end of the wire 4 projects the front end of the guide 5. As the laser device (thermal spraying material melting means) used in this embodiment there may be used a laser device with an output of 500W. The reference numeral 1a′ in the figure denotes a laser light incidence section.

A high-frequency electromagnetic induction coil 7 is wound round the thermal spraying nozzle 1 and is connected to a high frequency power supply 8. By applying a high frequency to the coil 7, the nozzle 1, which is made of a refractory metal such as tungsten is subjected to electromagnetic induction heating.

This heating is used for two purposes. The first purpose is cleaning the nozzle 1. This is because the particles may solidify and adhere to an inner wall 1c of the nozzle and so it is necessary to clean the interior of the nozzle periodically.

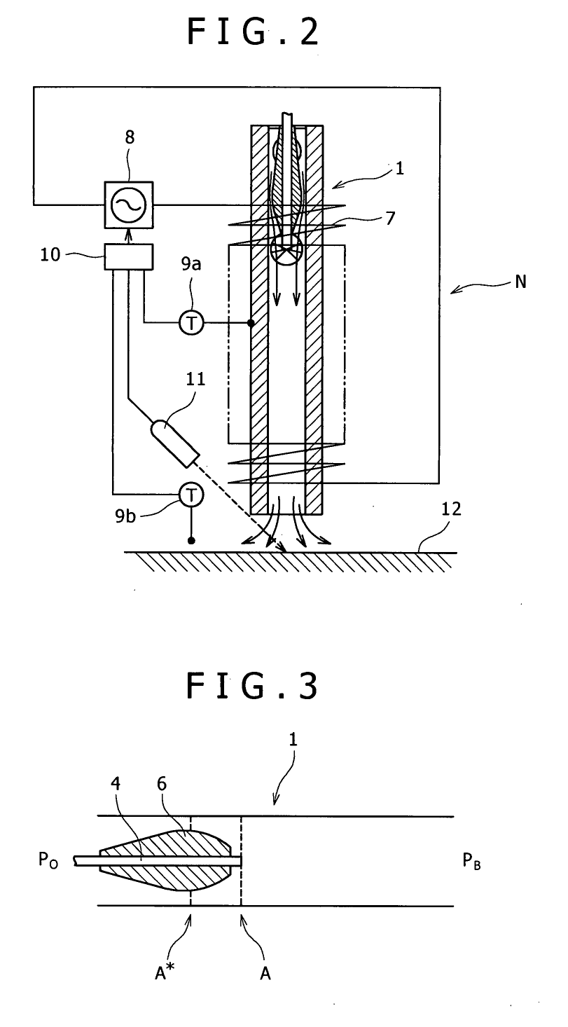

More specifically, as shown in FIG. 2, the nozzle 1 is subjected to high-frequency electromagnetic induction heating at a temperature of not lower than the melting point of the thermal spraying material and below the melting point of the nozzle metal, then carrier gas as is injected to remove the adhered particles. A thermocouple 9a is for detecting whether the nozzle 1 is in a heated state to a temperature of not lower than the melting point of the thermal spraying material.

The second purpose is adjusting the temperature of the carrier gas in the nozzle 1 to a predetermined temperature. In this case, the temperature of carrier gas is monitored directly by a thermocouple 9b disposed in a nozzle outlet portion and the monitored gas temperature is given to a nozzle heating control section 10.

The nozzle heating control section 10 controls the voltage to be applied to the coil 7 so that the temperature of the nozzle 1 becomes the melting point of the thermal spraying material or higher or the carrier gas temperature becomes a predetermined temperature. In case of adjusting the carrier gas temperature to the predetermined temperature, the heating control section 10 functions as temperature adjusting means.

A spot radiation thermometer 11 is disposed near the nozzle 1 and a surface temperature of a base material 12 detected by the radiation thermometer 11 is also given to the nozzle heating control section 10. That is, when the temperature of the base material 12 is low, it is necessary to raise the particle temperature. With the spot radiation thermometer 11, the temperature of the base material just before thermal spraying is measured and is used for feedback control.

In case of using the coil 7 as heating means for cleaning, heating is performed with a predetermined cycle when the thermal spraying process is not performed, while in case of using the coil 7 as particle temperature adjusting means, heating is performed in the thermal spraying process.

Using the thermal spraying nozzle device N having the above construction, the wire 4 is heat-melted with a laser beam on the downstream side relative to the throat portion 6.

The heat-melting section using a laser beam is positioned downstream side of the throat portion 6 in a carrier gas flow path within the nozzle 1 and is constructed so as to operate in a state in which a total carrier gas pressure pₒ satisfies the following expression (1):

$${p}_{0} \geq {{p}_{B} ( 1 + \frac{κ - 1}{2} {M}^{2} )}^{\frac{κ}{κ - 1}} \qquad ( 1 )$$

where, pₒ: total carrier gas pressure (throat upstream-side pressure), p_{B}: nozzle outlet back pressure, M: Mach number in the thermal spraying material melting section, κ: specific heat ratio of the carrier gas.

In accordance with the following expression (2) the Mach number M in the thermal spraying material melting section is associated with a sectional area A* of the throat portion 6 and a sectional area A (see FIG. 3) of the thermal spraying material heat-melting section.

$$\frac{A}{{A}^{*}} = {\frac{1}{M} [ \frac{( κ - 1 ) {M}^{2} + 2}{κ + 1} ]}^{\frac{κ + 1}{2 ( κ - 1 )}} \qquad ( 2 )$$

As is seen from the expression (1), in case of the carrier gas being nitrogen gas (κ=1.4), p_{B}/p₀≦0.0272 in a region downstream of the throat portion 6 where the Mach number is, say, 3 (M=3), and even if the pressure on the upstream side of the throat portion 6 is 3.7 MPa (p₀=3.7×10⁶ Pa), the pressure in a supersonic region after passing the throat portion 6 is 0.1 MPa corresponding approximately to the atmospheric pressure. Therefore, unlike the conventional powder supply system in cold spraying, any special pressure-proof design is not needed.

The thermal spraying material melted with a laser beam undergoes a shearing action caused by a supersonic gas flow and is atomized into fine particles.

In the literature Atomization and Spray, Arthur, Lefebvre, Taylor & Francis (publisher), p. 30-37, there is shown the following expression (3) as an empirical expression of an atomizing effect induced by a parallel flow.

$${( \frac{{ρ}_{A} {U}_{A}^{2} D}{σ} )}_{crit} = {We}_{crit} = 13 \qquad ( 3 )$$

where, 92 _{A}: gas density, U_{A}: gas-particles relative velocity, D: particle diameter, σ: droplet surface tension.

If a ferrous material is melted and injected into a gas flow of Mach number 3, it is presumed from the expression (3) that the ferrous material will be atomized to a diameter of 10 μm or smaller.

The particles after atomization undergo both accelerating and cooling actions under a supersonic gas flow and is eventually ejected from the nozzle 1 at a supersonic speed.

Acceleration and cooling in this period can be estimated by numeral value analysis. More particularly, a mass, momentum and energy conservation expression as a quasi-one-dimensional compressive fluid conservation type representation is solved by making the following expression (4) simultaneous with a particles motion equation (6):

$$\frac{\partial U}{\partial t} + \frac{\partial F}{\partial x} = S \\ where , \\ U = ( \begin{matrix}{ρ}_{g} A \\ {ρ}_{g} {Au}_{g} \\ {ρ}_{g} AE\end{matrix} ) , \\ F = ( \begin{matrix}{ρ}_{g} {Au}_{g} \\ {ρ}_{g} {Au}_{g}^{2} + p A \\ {ρ}_{g} {Au}_{g} H\end{matrix} ) , \\ S = ( \begin{matrix}0 \\ p \frac{\partial A}{\partial x} - π Df \frac{1}{2} {ρ}_{g} {u}_{g}^{2} + s \\ π {DNu}_{x} \frac{λ}{x} ( {T}_{W} - {T}_{g} ) + e\end{matrix} ) \\ E = \frac{1}{2} {u}_{g}^{2} + \frac{1}{κ - 1} \frac{p}{{ρ}_{g}} , \\ H = E + \frac{p}{{ρ}_{g}} \qquad ( 4 )$$

Provided, however, that the following expression (5) of Johnson-Rubeshin is used in connection with turbulent flow heat transfer of a nozzle wall 1b:

$${Nu}_{x} = 0.0296 {Pr}^{\frac{2}{3}} {Re}_{x}^{\frac{4}{5}} \qquad ( 5 )$$

In the above description, s and e stands for a momentum generation term and an energy generation term, respectively, which represent an interaction between gas phase and second phase.

The velocity of the particles can be obtained by solving the following particles' motion equation (6):

$$\frac{\partial {u}_{s}}{\partial t} = {u}_{s} \frac{\partial {u}_{s}}{\partial x} = \frac{{ρ}_{s} - {ρ}_{g}}{{ρ}_{s}} g - \frac{{u}_{s}}{{\dot{m}}_{s}} s \qquad ( 6 )$$

Provided, however, that:

$$s = \frac{3}{2} \frac{{\dot{m}}_{s} {C}_{D}}{{d}_{s} {ρ}_{s} {u}_{s}} \frac{1}{2} {ρ}_{g} ( {u}_{s} - {u}_{g} ) \vert {u}_{s} - {u}_{g} \vert \qquad ( 7 )$$

where Kurten's expression (8) is used for drag coefficient.

C_{D}=0.28+6Re^{-0.5}+21Re⁻¹ (8)

The temperature of the particles can be obtained by solving the following energy equation (9) of the particles:

$$Re = \frac{{ρ}_{g} \vert {u}_{s} - {u}_{g} \vert {d}_{s}}{μ} \\ \frac{\partial {h}_{s}}{\partial t} + {u}_{s} \frac{\partial {h}_{s}}{\partial x} = - \frac{{u}_{s}}{{\dot{m}}_{s}} ( q + e ) \qquad ( 9 )$$

Provided, however, that the following expression is applied in case of the nozzle wall 1b being a heat insulating wall with its temperature equal to the gas temperature:

$$e = \frac{6 {\dot{m}}_{s}}{{ρ}_{s} {u}_{s} {d}_{s}} \{ Nu \frac{λ}{{d}_{s}} ( {T}_{s} - {T}_{g} ) + αɛ ( {T}_{s}^{4} - {T}_{W}^{4} ) \} , q = 0 \qquad ( 10 )$$

The following expression is applied in case of the nozzle wall 1b being a heated isothermal wall:

$$e = \frac{6 {\dot{m}}_{s}}{{ρ}_{s} {u}_{s} {d}_{s}} Nu \frac{λ}{{d}_{s}} ( {T}_{s} - {T}_{g} ) , \\ q = \frac{6 {\dot{m}}_{s}}{{ρ}_{s} {u}_{s} {d}_{s}} αɛ ( {T}_{s}^{4} - {T}_{W}^{4} ) \qquad ( 11 )$$

Where, the following Ranz-Marshall expression (12) is used for Nusselt number:

$$Nu = 2 + 0.6 {Pr}^{\frac{1}{3}} {Re}^{\frac{1}{2}} \qquad ( 12 )$$

The symbols appearing in the above expressions have the following meanings:

A: sectional area of the nozzle

C_{D}: particle drag coefficient

D: nozzle diameter

d: particle diameter

f: wall surface friction coefficient

g: gravitational acceleration

h: specific enthalpy

\dot{m}: mass flow rate

Nu: Nusselt number

p: gas pressure

Pr: Prandtl number

Re: Reynolds number

T: temperature

u: flow velocity

x: distance in nozzle flow direction

α: Stefan-Boltzmann constant

ε: emissivity

κ: specific heat ratio

λ: thermal conductivity

μ: viscosity coefficient

ρ: density

The following are the meanings of subscripts:

g: gas

s: second phase (droplet, particle, powder)

x: distance from the nozzle throat portion

W: nozzle wall surface

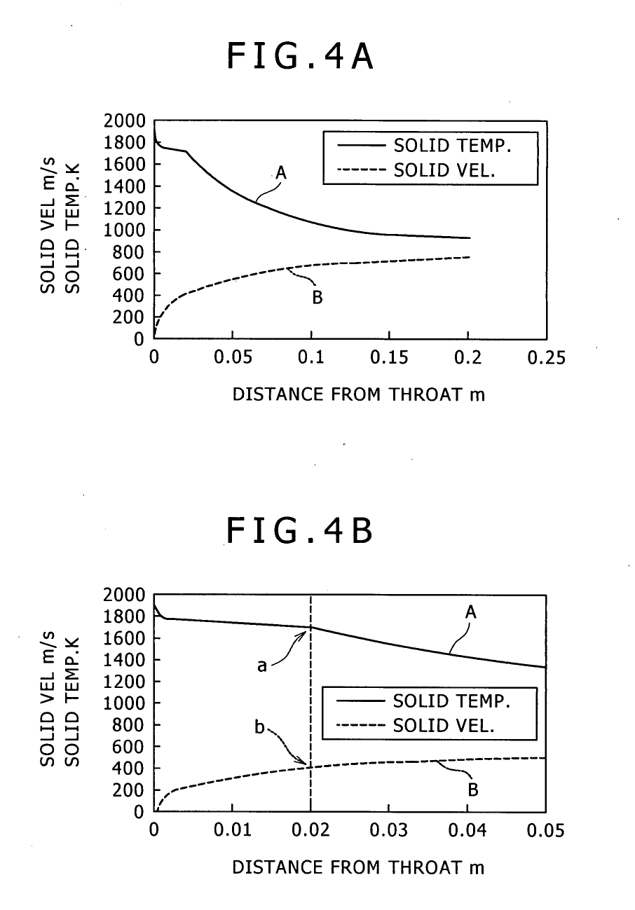

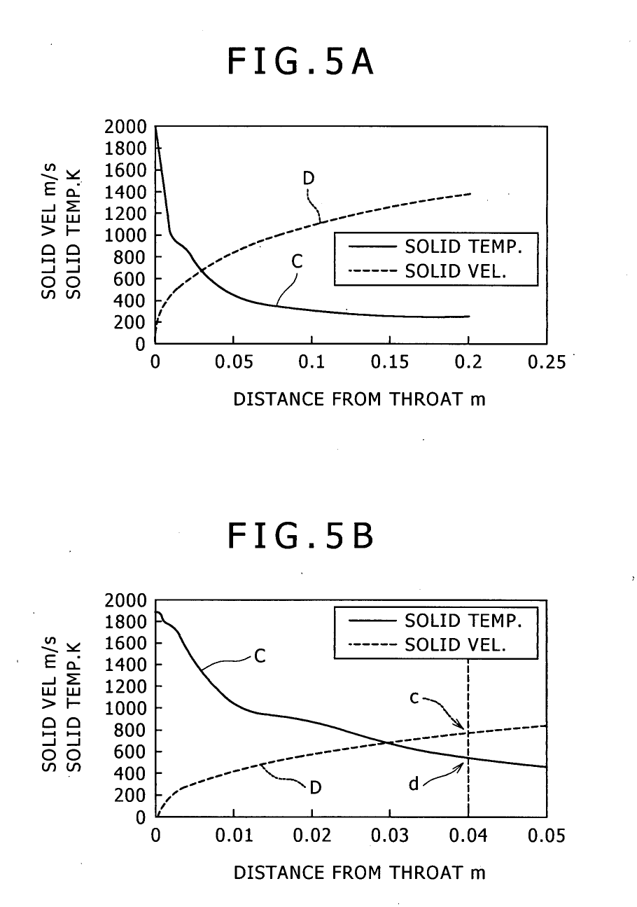

FIGS. 4 and 5 show a relation of intra-nozzle particle temperature and particle velocity to the distance from the throat portion 6 to the nozzle outlet in case of using nitrogen gas and helium gas respectively as carrier gases.

The graph of FIG. 4(a) shows a case where nitrogen gas is used as carrier gas, in which “the distance from the throat portion to the nozzle outlet” is plotted along the axis of abscissa, while “particle temperature” and “particle velocity” are plotted using a common scale along the axis of ordinate. In the axis of abscissa, “zero” corresponds to the position of the throat portion 6 and the characteristic A in the graph represents how the particle temperature changes, while the characteristic B in the graph shows how the particle velocity changes.

When the nozzle wall was heated so as to give a carrier gas temperature of 600° C. and the nitrogen gas pressure was set at 3.8 MPa, the gas flow rate at 1 g/s, the amount of the wire 4 supplied at 0.1 g/s as the thermal spray condition, an average diameter of atomized particles was 10 μm.

FIG. 4(b) is an enlarged diagram of the range from zero to 0.05 m in the direction of the axis of abscissa.

As shown in both figures, the particles ejected from the throat portion 6 are accelerated rapidly up to a distance of about 0.02 m, but thereafter the acceleration gradient becomes gentle. Therefore, the nozzle length of 0.02 m was adopted as a nozzle length in case of using nitrogen gas as carrier gas.

On the other hand, as to the particle temperature, after ejected from the throat portion 6, the particles continue to be cooled and at a distance of 0.02 m the particles temperature drops to about 1700K (see the point “a” in the graph). An impact velocity upon collision of the particles with the base material is about 400 m/s (see the point “b” in the graph).

Thus, in case of using nitrogen gas, the temperature upon collision of the particles with the base material is high and therefore in order to enhance the strength of a layer formed by thermal spraying it is necessary to perform a certain heat treatment for the base material. However, if a heat treatment is performed, a certain distortion is unavoidable in comparison with the shape just after molding.

Therefore, in the shape obtained by thermal spraying, if a finish error of about 0.2 mm is allowed or if finish machining is allowed after forming a laminate by thermal spraying, nitrogen gas may be used as carrier gas. In this case, the nozzle length may be set so that the particles collide with the base material just after their solidification.

More particularly, that the particles are in a state of just after solidification in the thermal spraying process exerts a good influence on the structure of the material used. When particles having an average particle diameter of 10 μm are flying through the interior of the nozzle 1, the particles are cooled rapidly at a cooling rate of 10⁴ to 10⁵ K/s by the heat transfer and the radiation with a surrounding gas, and the material resulting from adhesion of the particles thereto has an extremely dense structure. Accordingly, the nozzle length is set so that the particles can fly through the interior of the nozzle 1 until the end of solidification.

Next, the graph of FIG. 5(a) shows the state of intra-nozzle particles in case of using helium gas as carrier gas.

When the nozzle wall was heated so as to give a carrier gas temperature of 600° C. and thermal spraying conditions were set at a helium gas pressure of 3.8 MPa, a gas flow rate of 0.5 g/s and a wire 4 supply quantity at 0.1 g/s, an average diameter of atomized particles was 10 μm.

Characteristics C and D in the graph represent the transition of the particle temperature and that of the particle velocity, respectively. FIG. 5(b) is an enlarged diagram of the range from zero to 0.05 m in the direction of the axis of abscissa.

In case of using helium gas as carrier gas, the particles continue to be accelerated up to about 1400 m/s because the molecular weight of helium is small. On the other hand, as to the temperature of the spraying material particles, since the thermal conductivity of helium is high, the particles are cooled rapidly after ejected from the throat portion 6 and the temperature thereof drops to 300K in the nozzle outlet.

In view of the measurement results shown in FIG. 5, since tempering generally does not occur if the temperature is not higher than 540K, the nozzle length in case of using helium gas as carrier gas was set at 0.04 mm. When the particles collide with the base material, the particle temperature is about 540K (see the point “d” in the graph) and the impact velocity is about 780 m/s (see the point “c” in the graph).

The particle velocity of 780 m/s is a sufficient velocity as a condition for adhesion by collision to the base material. Accordingly, if thermal spraying is performed under the conditions set in this embodiment, the particles are deposited on the base material.

The particle temperature upon collision with the base material is much lower than that (1700K) in the use of nitrogen gas described above, so that heat treatment after the molding is not necessary and there scarcely occurs any distortion. Besides, since the particle velocity upon collision is high, the deposition of the particles is continued while the particles-struck surface becomes cratered. At this time, in the interior of the deposited layer there is formed a film having a stable thickness and with 100% density free of void.

In the three-dimensional deposition molding method, the characteristics of the thermal spraying nozzle device according to the present invention brings about an outstanding effect.

First, in comparison with selective laser sintering (SLS), the cost is reduced because the forming material (thermal spraying material) is used in the form of a wire rod.

Moreover, in the SLS method there are used spherical particles coated with a thermoplastic resin and therefore two sintering steps are needed for obtaining a metal molding. More specifically, there are needed a laser sintering step of melting and solidifying the resin portion with use of a laser heat source and a main sintering step of removing a binder from the laser-sintered molding and at the same time allowing metal particles to be fixed together.

On the other hand, in the thermal spraying nozzle device of this embodiment, it-is not necessary to coat the particles with resin, nor is it necessary to perform infiltration of bronze or the like in order to enhance the density of a porous body resulting from removal of the binder. Thus, according to this embodiment it is possible to overcome the drawbacks of the SLS method and obtain a highly accurate laminate.

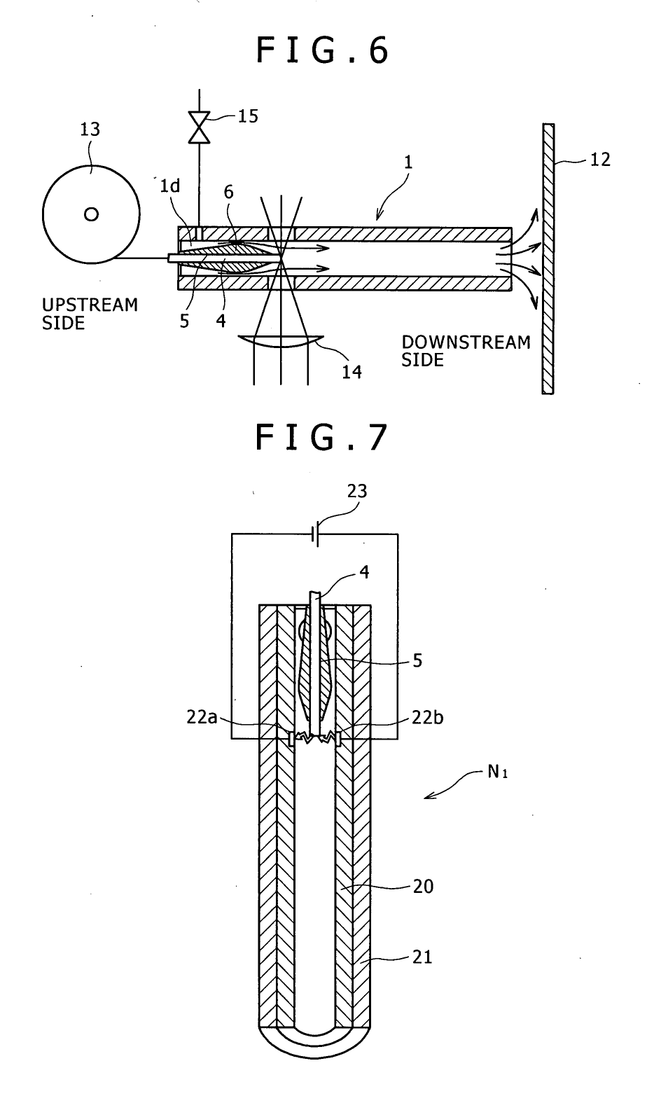

FIG. 6 shows a construction in case of performing a film forming process with use of the thermal spraying nozzle device N constructed as above.

In the same figure, the base material 12 is disposed on an extension line in the axial direction of the nozzle 1.

The wire 4 is unwound from a wire reel (a thermal spraying material supply device) 13 and is supplied into the nozzle 1 while passing through the interior of the guide 5 which is disposed along the axis of the thermal spraying nozzle 1. The front end of the wire 4 projects from the front end of the guide 5.

With a lens 14, laser light is focused on the front end of the projecting wire 4, whereby the front end of the wire 4 is melted.

On the other hand, the flow rate of the carrier gas is controlled by a control valve 15 and the carrier gas is supplied to the upstream side of the throat portion 6. The carrier gas thus supplied passes through the throat portion 6 and is thereby accelerated into a supersonic gas, whereby the thermal spraying material at the melted front end of the wire 4 is atomized.

Particles of the atomized thermal spraying material are cooled rapidly when leaving the throat portion 6, but since the interior of the nozzle 1 is heated by the coil 7, the particles collide with the surface of the base material 12 in a state in which the temperature of the particles is adjusted to a high temperature of not higher than the solidifying point temperature or not higher than the transformation point temperature.

FIG. 7 illustrates a thermal spraying nozzle device N according to another embodiment of the present invention.

In the thermal spraying nozzle device N₁ shown in the same figure, a nozzle 20 is constituted by a ceramic cylinder, and a tungsten cylinder 21 is wound concentrically round the outer periphery of the nozzle 20.

A pair of discharging electrodes 22a and 22b are disposed opposedly to each other on the-inner wall of the nozzle 20 at positions near the front end of the guide 5, and DC voltage 23 (AC voltage or pulse voltage will do as well) is applied between those electrodes.

When DC voltage is applied to the electrodes 22a and 22b, there occurs an electric discharge between both electrodes, causing an electric current to flow, so that the front end of the wire 4 projecting between the electrodes is melted with joule heat. In this construction, the electrodes 22a, 22b and the DC voltage 23 function as thermal spraying material melting means.

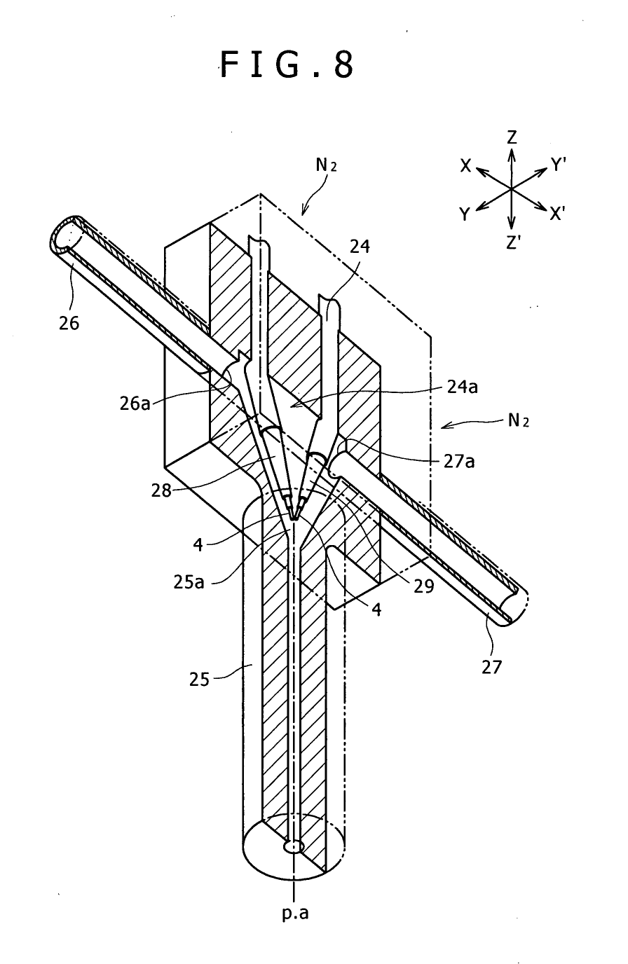

FIG. 8 illustrates a thermal spraying device N according to a further embodiment of the present invention.

In this thermal spraying device, a pair of wires are inserted into a nozzle and arc discharge is performed using those wires as electrodes.

In the same figure, to provide an understanding of an internal structure, the device is divided in two in Z-Z′ direction and one of the thus-divided sections is shown.

The thermal spraying device N₂ includes a body portion 24 of a pressure-resisting structure provided in the interior thereof with a hollow chamber 24a, a nozzle portion 25 extended in Z′ axis direction from the body portion 24, and two carrier gas supply pipes (hereinafter referred to simply as the “supply pipes”) 26 and 27 connected to the body portion 24 from opposed sides along X-X′ axis.

More specifically, in the interior of the body portion 24 is formed the hollow chamber 24a which is triangular in shape when seen in Y-Y′ direction and elliptic when seen in Z-Z′ direction. Guides 28 and 29 for guiding two wires 4 are disposed in V shape within the chamber 24a in such a manner that the wires 4, 4 fed out from front ends of the guides 28 and 29 intersect each other on the central axis p.a of the nozzle portion 25. The guides 28 and 29 are each constituted by a cylindrical member which is tapered in Z′ direction.

Rear ends of the pair of wires 4, 4 are connected to DC voltage (not shown) and front ends of the wires 4, 4 constitute electrodes for generating arc discharge. Thus, the wires 4, 4 and the DC voltage function as thermal spraying material melting means.

In a base end of the nozzle portion 25 is formed a conical cutout portion 25a for disposing within the nozzle portion 25 the front end portions of the guides 28 and 29 constructed as above and the wires 4, 4.

The supply pipes 26 and 27 are in communication with the hollow chamber 24a and the guide 28 is disposed near an outlet 26a of the supply pipe 26, while the guide 29 is disposed near an outlet 27a of the supply pipe 27. According to such a construction, the guides 28 and 29 can be allowed to function as collision plates for collision with carrier gas flows discharged from the supply pipes 26 and 27. Consequently, it is possible to attenuate a dynamic pressure component of carrier gas into a static pressure component acting isotropically within the hollow chamber 24a.

As a result, the flow velocity of carrier gas in the hollow chamber 24a is decreased, a rotating flow becomes weak, and the flow velocity distribution of carrier gas flowing in the hollow chamber 24a and the nozzle portion 25 communicating with the hollow chamber becomes constant. Thus, the spraying material particles after melting and atomization can be drawn straight into the nozzle portion 25.

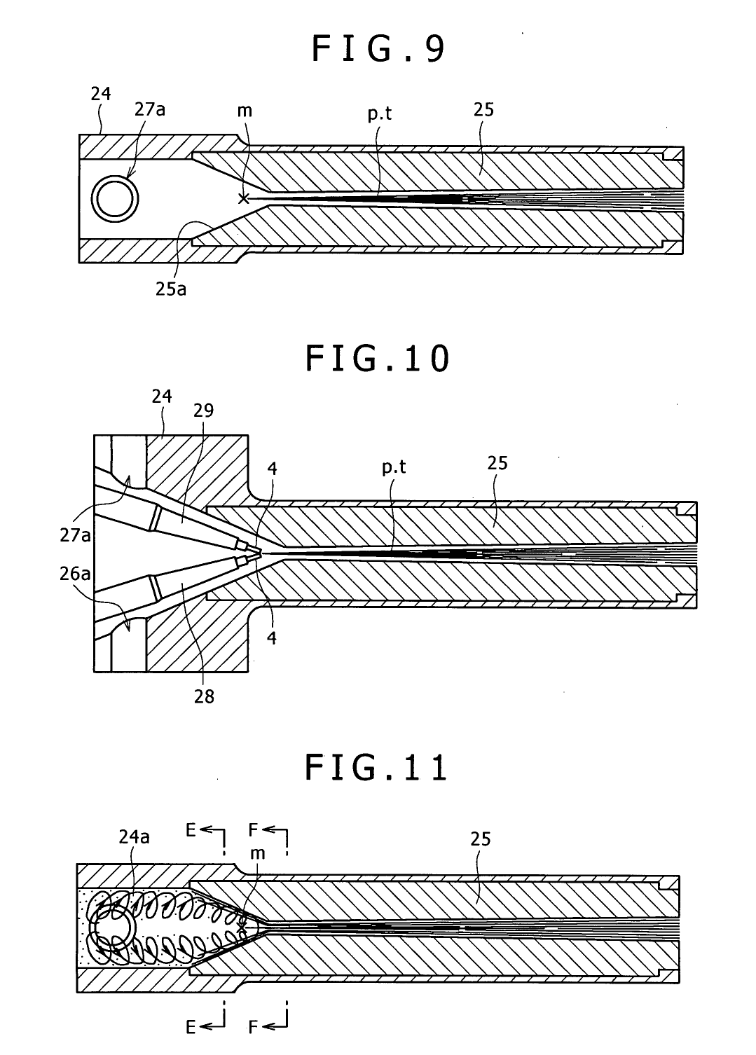

FIG. 9 is a side view of the thermal spraying nozzle device N₂, in which p.t represents a flying trace of the thermal spraying material particles. As is seen from the same figure, the particles move straight ahead from an arc melting point, m, toward the nozzle portion 25 without collision with the inner wall of the nozzle.

FIG. 10 is a plan view of the thermal spraying nozzle device N₂, from which it is seen that the flying trace p.t of the thermal spraying particles advances straight without expanding in the transverse direction.

However, it is the flying traces of the thermal spraying particles obtained by numerical analysis that are shown in FIGS. 9 and 10.

FIG. 11 is a side view showing a flow of carrier gas in the interior of the hollow chamber 24a. As shown in the same figure, near the arc melting point, m, there is formed a branch point at which the flow of carrier gas is divided up and down in the interior of the hollow chamber 24a.

A main flow component of carrier gas is only an axial component advancing toward the nozzle portion 25.

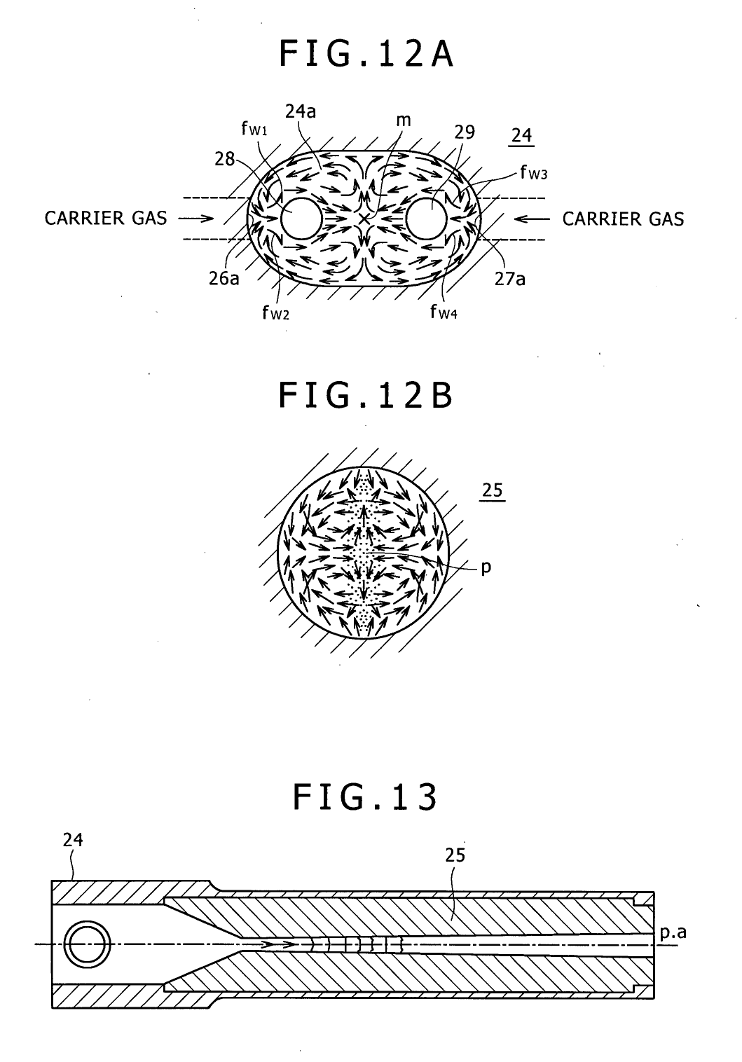

With reference to a schematic diagram of FIG. 12, a description will be given below about in what manner the carrier gas is divided up and down.

FIG. 12(a) shows a section as seen in the arrowed direction E-E in FIG. 11, and FIG. 12(b) shows a section as seen in the arrowed direction F-F in FIG. 11.

In FIG. 12(a), the carrier gas discharged from the outlet 26a of the supply pipe 26 collides with a side wall of the guide 28, whereby a dynamic pressure component thereof is attenuated and the gas flow is divided substantially into two upper and lower flows fw₁, fw₂. Likewise, the carrier gas discharged from the outlet 27a of the supply pipe 27 collides with a side wall of the guide 29 and is thereby divided substantially into two upper and lower flows fw₃, fw₄ in an attenuated state of its dynamic pressure component.

The carrier gas flows fw₁, fw₂ and fw₃, fw₄ thus divided by the guides 28 and 29, respectively, form counter flows toward the center of the hollow chamber 24a and collide with each other at the central part of the hollow chamber 24a, whereby they are converted into flows rotating with the arc melting point, m, as point symmetry. As a result, in the vicinity of the arc melting point, m, there is formed a flow region not having velocity in x-y section.

In this state the carrier gas advances to the nozzle portion 25, in which there are formed such carrier gas flows as shown in FIG. 12(b). As a result, melted and atomized particles, p, fly through the interior of the nozzle portion 25 while being sandwiched in between the carrier gas flows.

FIG. 13 shows a flow velocity distribution of the carrier gas passing on the central axis p.a of the nozzle portion 25. The flow velocity distribution is represented by plural lines extending perpendicularly to the flow direction, but the particles P concentrated on the nozzle axis seldom come into contact with the wall surface because the plural lines are symmetric with respect to the nozzle axis.

Although two wires 4, 4 are used in the thermal spraying nozzle device N₂ described above, a larger number of wires may be used, and the number of guides for the supply of wires may be set to a number corresponding to the number of wires used.

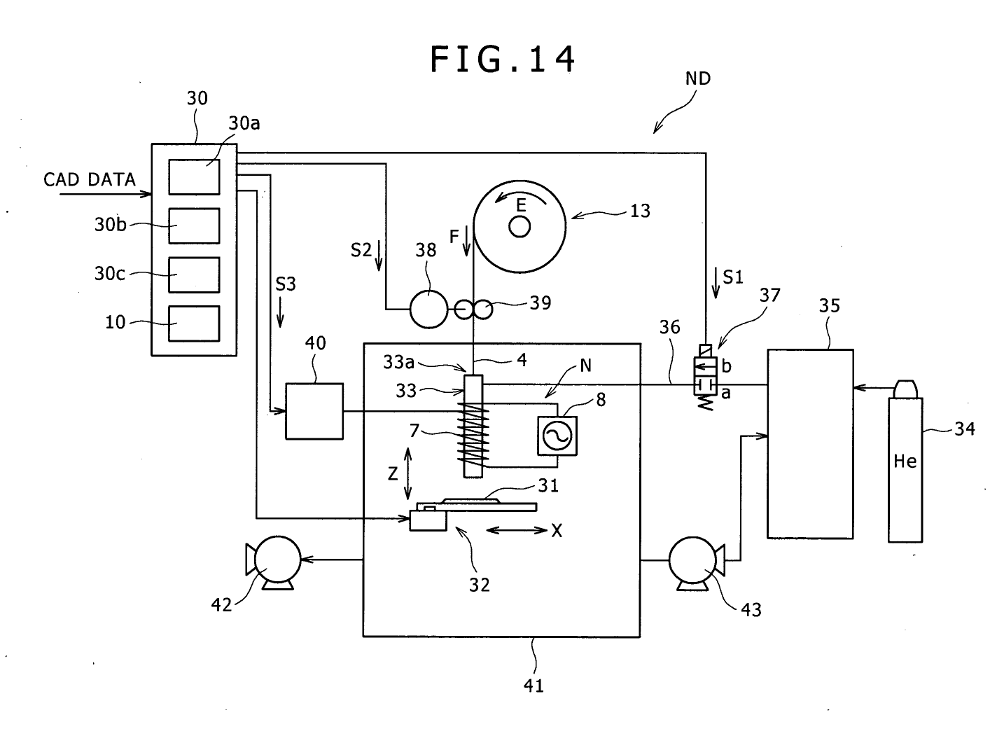

FIG. 14 shows a construction in case of applying the thermal spraying nozzle device N described above to a three-dimensional deposition molding method.

In a thermal spray system ND shown in the same figure, the numeral 30 denotes a controller to read in 3D (three-dimensional) CAD data.

On the basis of the 3D (three-dimensional) CAD data thus read in the controller 30 prepares sectional data sliced to a laminate thickness, then on the basis of the sectional data the controller 30 deposits thermal spraying material particles melted by laser light or by arc discharge layer by layer onto a base material 31 to afford a three-dimensional solid model (molding) of a desired shape. A description will be given below with reference to an example in which the thermal spraying material is melted with laser light.

The base material 31 is provided on a conveyance table 32 capable of being moved in X, Y (in the depth direction of paper) and Z axis directions and a nozzle 33 is attached to a robot arm (not shown). A drive mechanism comprising the conveyance table 32 and the robot arm can control the movement in the three-axis directions with use of a drive system control section 30a in the controller 30.

Helium as carrier gas is once stored into a helium chamber 35 from a helium cylinder 34, the helium chamber 35 and the nozzle 33 being connected together through a gas supply path 36. An electromagnetic control valve 37 is disposed in the gas supply path 36.

The electromagnetic control valve 37 has an OFF position, a, and an ON position, b, and normally occupies the OFF position, a, under the action of a spring pressure. But during the period in which an OPEN signal S1 is inputted from the supply system control section 30b in the controller 30 the valve 37 switches to the ON position, b.

Wire 4 as a thermal spraying material to be fed to the nozzle 33 is in a wound-up state onto a wire reel 13 and the wire 4 when rewound from the wire reel 13 is fed to the nozzle 33 by driving rollers 39. The driving rollers 39 are adapted to rotate by a stepping motor 38 which can be controlled with pulses. The stepping motor 38 is controlled by the supply system control section 30b.

More specifically, when a FEED signal S2 is provided to the stepping motor 38 from the supply system control section 30b, the driving rollers 39 rotate in accordance with the number of outputted pulses, causing the wire reel 13 to rotate in the direction of arrow E, whereby the wire 4 is fed out in the direction of arrow F and is introduced into the nozzle 33 from an upper end 33a (inlet side) of the nozzle 33.

When a front end of the wire 4 projects from the front end of the guide 5 in the nozzle 33 (see FIG. 1), a shutter OPEN signal S3 for opening a shutter of a laser circuit is provided to a laser device 40 from an output control section 30c in the controller 30 and laser light emitted from the laser device 40 focuses at the projecting front end of the wire 4 to melt the wire.

The wire 4 melting operation by the laser device 40 premises output of the OPEN signal S1 from the supply system control section 30b. In this state, carrier gas is fed into the nozzle 33 from the helium chamber 35. Consequently, melted particles are ejected from the nozzle 33 to the base material 31 by the carrier gas a supersonic gas.

The nozzle 33, the associated robot arm and the conveyance table 32 are accommodated within a chamber 41 which can afford an airtight condition. The interior of the chamber 41 is evacuated by a vacuum pump 42, whereby oxygen is removed. Within the controller 30, the numeral 10 denotes the nozzle heating control section shown in FIG. 2.

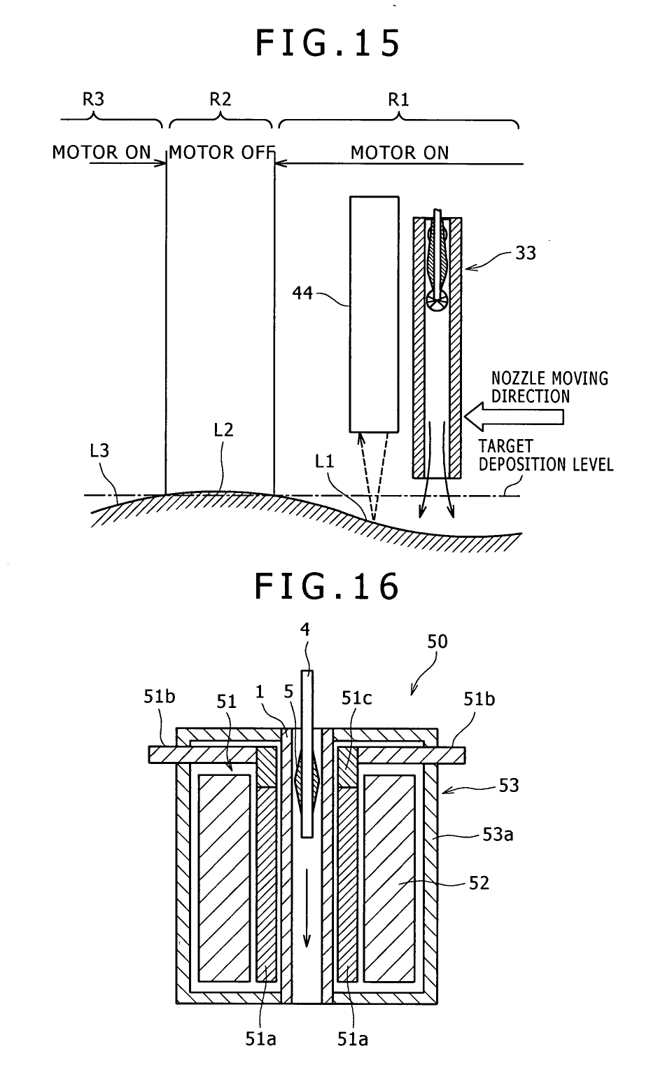

FIG. 15 shows in what manner the amount of the particles to be deposited is controlled by the supply system control section 30b.

A position sensor 44 is disposed on the font side in the moving direction of the nozzle 33. The position sensor 44 measures the distance between a front end of the nozzle 33 and an already deposited laminate surface on the base material 12 and provides the measurement result to the supply system control section 30b.

In accordance with the detected distance the supply system control section 30b controls the stepping motor 38 to actuate the driving rollers 39. For example, at a range R1, an already deposited level L1 is lower than a target deposition level, indicating that the amount is deposition is short. In this case, the stepping motor 38 is operated to continue feeding the wire 4 toward the laser focus through the driving rollers 39.

On the other hand, when the position sensor 44 detects an already deposited level L2 which satisfies the target deposition level, the stepping motor 38 is turned OFF because deposition is not necessary, whereby the wire 4 is not supplied and the thermal spraying stops.

Next, when the position sensor 44 detects an already deposited level L3, since this indicates the lack of deposition, the stepping motor 38 is turned ON to resume supply of the wire 4, whereby the thermal spraying material particles are sprayed so as to reach the target deposition level.

Referring back to FIG. 14, a description will be given below.

Numeral 43 denotes a helium compressor for the recovery of helium. With the helium compressor 43, the helium present within the chamber 41 is compressed into high-pressure helium, which is returned to the helium chamber 35. In this way the expensive helium is re-utilized.

The wire 4 described in the above embodiments may be a single metal wire or a stranded wire of plural metallic materials. In case of using the thermal spraying nozzle device N₂ shown in FIG. 8, the material of one wire 4 and that of the other wire 4 may be different.

FIG. 16 shows an other example of heating means for heating the nozzle.

In the embodiments described above, the nozzle 1 is subjected to high-frequency induction heating with use of the coil 7 disposed around the nozzle 1 to clean the metal adhered to the inner surface of the nozzle 1, thereby preventing the flow of carrier gas from being disturbed by the metal adhered into the nozzle 1 and the resulting deterioration of the thermal spraying accuracy (see FIG. 2)

According to this heating method, however, a portion of energy of the electromagnetic wave released from the coil 7 is not utilized for heating the nozzle 1 and therefore the ratio of heat energy used for heating the nozzle 1 is low relative to electrical energy applied to the coil 7. For this reason, such a heating device 50 as shown in FIG. 16 may be used for enhancing the energy efficiency in nozzle temperature adjustment and nozzle cleaning.

The heating device 50 shown in the same figure is provided with a carbon heater 51 which is disposed so as to enclose the nozzle 1.

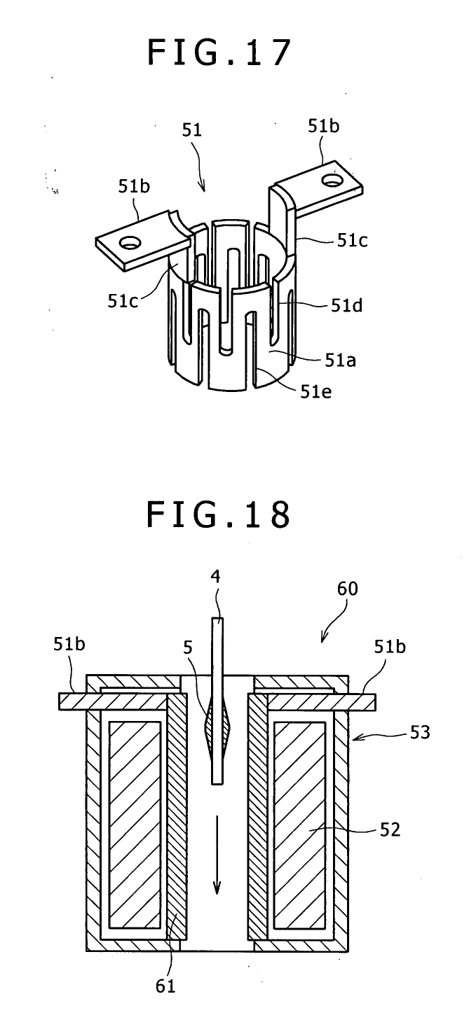

As shown in FIG. 17, the carbon heater 51 is made up of a cylindrical heating portion 51a, a pair of electrode portions 51b, 51b disposed in opposite directions above the heating portion 51a, and a pair of electrode connecting portions 51c, 51c which connects the electrode portions 51b, 51b and an upper end of the heating portion 51a with each other.

The heating portion 51a is divided into plural portions by slits 51d and 51e which are formed at a predetermined length alternately from both upper and lower sides of the cylindrical body.

Further, as shown in FIG. 16, a cylindrical heat insulator 52 made of carbon fiber is disposed so as to surround the outer periphery of the carbon heater 51 and a chamber 53 for accommodating the heat insulator 52 is further provided.

Inert gas is sealed within the chamber 53 for the purpose of preventing oxidation of the carbon parts. Front ends of the electrode portions 51b are extended in a sealed state to the exterior through a side wall 53a of the chamber 53 so that they can be connected to a power supply (not shown).

Next, the following description is provided about a case where a cleaning operation is performed by the heating device 50 having the above construction.

When electric power is supplied from the power supply (not shown) to the heating portion 51a through the electrode portions 51b, 51b and the electrode connecting portions 51c, 51c, the carbon heater 51 generates heat from the interior due to Joule heat generated by the supply of electric power. As a result, the nozzle 1 made of a refractory metal such as tungsten or molybdenum or a ceramic material is heated to about 2000° C. by radiation heat transmitted from the heating portion 51a, whereby the metal adhered to the inner wall of the nozzle 1 is melted.

Next, by ejecting carrier gas into the nozzle 1, the melted metal is discharged to the exterior of the nozzle 1 to effect cleaning.

FIG. 18 shows a further example of a heating device.

In the heating device 50 shown in FIG. 16 the carbon heater 51 is disposed around the nozzle 1 to heat the nozzle 1, while in a heating device 60 shown in FIG. 18 the nozzle made of a refractory metal or a ceramic material is substituted by a carbon nozzle 61 and the carbon nozzle 61 is heated directly. In FIG. 18, the same constituent elements as in FIG. 16 are identified by the same reference numerals as in FIG. 16 and explanations thereof will be omitted.

In the heating device 60, the nozzle 61 itself is constituted by carbon or carbon composite and functions as a heating portion, and a pair of electrode portions 51b, 51b are connected in opposite directions to an upper end portion of the nozzle 61.

Next, a description will be given about a case where a cleaning operation is performed using the heating device 60 having the above construction.

When electric power is supplied from a power supply (not shown) to the nozzle 61 through the electrode portions 51b, 51b, the nozzle 61 generates heat from the interior thereof due to Joule heat generated by the supply of electric power. As a result, the nozzle 61 is heated to about 2000° C. and the metal adhered to the inner wall of the nozzle 61 is melted thereby.

Then, by injecting carrier gas into the nozzle 1, the melted metal is discharged to the exterior of the nozzle 61 to effect cleaning.

In comparison with the case where the thermal spraying nozzle is subjected to induction heating with use of a high-frequency induction coil, the use of the carbon heater 51 as means for heating the nozzle is advantageous in that the utilization efficiency of energy used in heating the thermal spraying nozzle can be enhanced.

Further, in comparison with the construction using the carbon heater 51, the construction using the carbon nozzle 61 is advantageous in that the number of parts can be reduced and that therefore maintenance is easy.

Thus, with the heating devices 50 and 60 having the above constructions, as compared with heating the nozzle 1 by using the coil 7, the loss of energy used for heating the nozzle can be diminished at the time of adjusting the nozzle temperature or at the time of nozzle cleaning.

### INDUSTRIAL APPLICABILITY

The thermal spraying nozzle device and the thermal spraying system using the same both according to the present invention are suitable in a field requiring formation of a uniform and compact metal laminate on a base material.

1. A thermal spraying nozzle device wherein carrier gas is introduced into an inlet side of a nozzle to form a supersonic gas flow in the entire region inside the nozzle and thermal spraying material is atomized and ejected by said gas flow, said thermal spraying nozzle device comprising,
a thermal spraying material inserting section inserting said thermal spraying material formed in a linear shape into the nozzle from the inlet side substantially in parallel with the gas flow, and,
a thermal spraying material melting means heating and melting said thermal spraying material projected from said thermal spraying material inserting section in the vicinity of a front end of said thermal spraying material inserting section,
wherein said thermal spraying nozzle device is configured such that particles of the thermal material melted and atomized through said thermal spraying material melting means are quickly cooled by the supersonic gas flow in the nozzle and then ejected in a solidified or semi-solidified state.

2. The thermal spraying nozzle device according to claim 1, wherein a laser device adapted to focus near the front end of said thermal spraying material inserting section is provided as said thermal spraying material melting means.

3. The thermal spraying nozzle device according to claim 1, wherein as said thermal spraying material melting means a pair of discharging electrodes are provided in a mutually opposed state on the inner wall of the nozzle so that an arc discharge occurs near the front end of said thermal spraying material inserting section.

4. The thermal spraying nozzle device according to claim 1, wherein said thermal spraying material inserting section is constructed so as to permit insertion of plural pieces of said thermal spraying material into said nozzle, and front end portions of the thermal spraying material pieces are formed as discharging electrodes for generating an arc discharge, thereby constituting said thermal spraying material melting means.

5. The thermal spraying nozzle device according to claim 4, further comprising a hollow chamber formed on the inlet side of said nozzle and two carrier gas supply pipes communicating with said hollow chamber to introduce the carrier gas as counter flows, and wherein said thermal spraying material inserting section comprises cylindrical thermal spraying material inserting sections disposed respectively at positions where they collide with the carrier gas discharged from said carrier gas supply pipes toward said hollow chamber.

6. The thermal spraying nozzle device according to claim 1, wherein as said thermal spraying material inserting section a hollow pipe of a circular section is disposed on the central axis of said nozzle, a part of an outer wall of said hollow circular pipe being formed thick to form a throat portion between the hollow circular pipe and the inner wall of the nozzle.

7. The thermal spraying nozzle device according to claim 1, further comprising heating means for heating solidified particles of the thermal spraying material adhered to the inner wall of said nozzle up to a temperature of not lower than the melting point of the particles.

8. The thermal spraying nozzle device according to claim 7, wherein said heating means is configured so as to heat the particles of the thermal spraying material in said nozzle during thermal spraying.

9. The thermal spraying nozzle device according to claim 7, wherein a high frequency induction coil wound round said nozzle is used as said heating means.

10. The thermal spraying nozzle device according to claim 7, wherein as said heating means a carbon heater is provided around said nozzle.

11. The thermal spraying nozzle device according to claim 7, wherein as said heating means said nozzle itself is constituted by carbon or carbon composite provided with an electrode portion.

12. The thermal spraying nozzle device according to claim 1, further comprising temperature adjusting means for adjusting the temperature of the thermal spraying material particles in said nozzle to a predetermined temperature.

13. The thermal spraying device according to claim 1, wherein said thermal spraying material is formed of different materials.

14. A thermal spraying system comprising:
the thermal spraying nozzle device a thermal spraying material inserting section inserting said thermal spraying material formed in a linear shape into the nozzle from the inlet side substantially in parallel with the gas flow, and a thermal spraving material melting means heating and melting said thermal spraying material projected from said thermal spraying material inserting section in the vicinity of a front end of said thermal spraying material inserting section, wherein said thermal spraying nozzle device is configured such that particles of the thermal material melted and atomized through said thermal spraying material melting means are quickly cooled by the supersonic gas flow in the nozzle and then ejected in a solidified or semi-solidified state, wherein a laser device adapted to focus near the front end of said thermal spraying material inserting section is provided as said thermal spraying material melting means, wherein as said thermal spraying material melting means a pair of discharging electrodes are provided in a mutually opposed state on the inner wall of the nozzle so that an arc discharge occurs near the front end of said thermal spraying material inserting section, wherein said thermal spraying material inserting section is constructed so as to permit insertion of plural pieces of said thermal spraying material into said nozzle, and front end portions of the thermal spraying material pieces are formed as discharging electrodes for generating an arc discharge, thereby constituting said thermal spraying material melting means, further comprising a hollow chamber formed on the inlet side of said nozzle and two carrier gas supply pipes communicating with said hollow chamber to introduce the carrier gas as counter flows, and wherein said thermal spraying material inserting section comprises cylindrical thermal spraying material inserting sections disposed respectively at positions where they collide with the carrier gas discharged from said carrier gas supply pipes toward said hollow chamber, wherein as said thermal spraying material inserting section a hollow pipe of a circular section is disposed on the central axis of said nozzle, a part of an outer wall of said hollow circular pipe being formed thick to form a throat portion between the hollow circular pipe and the inner wall of the nozzle, further comprising heating means for heating solidified particles of the thermal spraying material adhered to the inner wall of said nozzle up to a temperature of not lower than the melting point of the particles, wherein said heating means is configured so as to heat the particles of the thermal spraying material in said nozzle during thermal spraying, wherein a high frequency induction coil wound round said nozzle is used as said heating means, wherein as said heating means a carbon heater is provided around said nozzle, wherein as said heating means said nozzle itself is constituted by carbon or carbon composite provided with an electrode portion, further comprising temperature adjusting means for adjusting the temperature of the thermal spraying material particles in said nozzle to a predetermined temperature, wherein said thermal spraying material is formed of different materials;
a carrier gas supply unit for the supply of carrier gas, said carrier gas supply unit being connected to said nozzle through a conduit;
a thermal spraying material supply unit for feeding said thermal spraying material formed in a linear shape into said thermal spraying material inserting section; and
a power supply unit for applying voltage to the discharging electrodes or the laser device serving as said thermal spraying material melting means.

15. The thermal spraying system according to claim 14, further comprising:
a control valve disposed in said conduit to control the flow rate of the carrier gas supplied from said carrier gas supply unit;
a reel serving as said thermal spraying material supply unit and with said linear thermal spraying material wound thereon;
a driving roller for introducing said thermal spraying material into said thermal spraying material inserting section while unwinding the thermal spraying material from said reel; and
a supply system control section for controlling opening/closing of said control valve and rotation/stop of said driving roller.

16. The spray system according to claim 15, further comprising a motor for rotating said driving roller and a position sensor for measuring the distance just before deposition from said thermal spraying nozzle up to an already deposited surface, said supply system control section being constructed so as to read in three-dimensional CAD data and control the rotation of said motor in accordance with a difference between a level detected by said position sensor and the level of a target deposition surface in the three-dimensional CAD data.

17. The thermal spraying system according to claim 14, further comprising an output control section for controlling voltage to be applied to said discharging electrodes output or said laser device.

18. A thermal spraying system according to claim 17, wherein said thermal spraying material melting means comprises a laser device and a laser light transmitting optical fiber, said laser light transmitting optical fiber providing a connection between said laser device and said nozzle, and said output control section is configured to control opening and closing of a shutter of said laser device.

19. The thermal spraying system according to claim 14, further comprising a temperature sensor for detecting the temperature of gas ejected from the nozzle, heating means disposed around said nozzle or serving as said nozzle, and temperature adjusting means for adjusting the temperature of the thermal spraying material particles in said nozzle to a predetermined temperature, said temperature adjusting means being configured so as to control voltage to be applied to said heating means on the basis of the temperature detected by said temperature sensor.

20. The thermal spraying system according to claim 14, further comprising a drive mechanism for displacing the attitude of said nozzle and a drive system control section for controlling said drive mechanism, said drive system control section reading in three-dimensional CAD data, then preparing sectional data sliced to a laminate thickness on the basis of the three-dimensional CAD data thus read in and then, on the basis of said sectional data, controlling said drive mechanism in such a manner that the thermal spraying material particles melted by said thermal spraying material melting means are deposited layer by layer on the base material.
